(19) United States
(12) Patent Application Publication
(10) Pub. No.: US 2011/0000038 A1
(43) Pub. Date: Jan. 6, 2011

(54) DEVICE FOR MOVEMENT WITHIN A PIPELINE

(76) Inventor: Harald Wittersø, Sandnes (NO)

Correspondence Address: GABLE & GOTWALS, 100 WEST FIFTH STREET, 10TH FLOOR, TULSA, OK, 74103, US

(21) Appl. No.: 12/918,058

(22) PCT Filed: Feb. 11, 2009
(86) PCT No.: PCT/NO2009/000050

§ 371 Date: Aug. 30, 2010

(30) Foreign Application Priority Data
Feb. 22, 2008 (NO) 2008 0962

(51) Int. Cl. B08B 9/00

(52) U.S. Cl. 15/104.05

(57) ABSTRACT

The present invention is a device for movement within a pipeline (2), as for instance a plug, comprising a main body and gripping means (3) comprising at least two gripping segments arranged movable between a retracted position out of contact with an inner wall (21) of a pipeline (2) and an extended position in contact with an inner wall (21) of a pipeline (2). According to the invention the device comprises at least two protection means (5) arranged extending in a radial direction from a main outer diameter (110) of the main body and arranged around a circumference of the main body, where a distal end (51) of the protection means (5) is extending outside the grip segments (14) in an retracted state of the grip segments (14) but is within an outer diameter (143) of the grip segments (14) in an extended state of the grip segments (14).

### CROSS REFERENCE TO RELATED APPLICATIONS

This application is the United States designated National Phase of PCT Application No. NO2009/000050 filed 11 Feb. 2009, which was published in English on 27 Aug. 2009 under No. WO2009/104969A1, which claims priority to Norwegian Patent Application No. 20080962 filed 22 Feb. 2008.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

The present invention relates to a device for movement within a pipeline. The device comprises a main body and gripping means, arranged moveable between a retracted and extended position, for interaction with an inner wall of a pipeline to keep the device in a fixed position within the pipeline.

There is a general need for performing work on pipelines, this may be surveying, repair of a given section, branching and other types of maintenance work. To perform such work there are often introduced devices, as pigs or plugs into the pipeline, at given positions. These pigs or plugs are pigged or in another manner moved within the pipeline to the desired location for performing the necessary work. If the work needs the pig or plug to be at specific locations, the device will normally comprise gripping means which are actuated when the device is in the desired location to interact with the inner wall of the pipeline and keep the device steady in relation to the pipeline, examples of plug for use within a pipeline is described in for instance the applicant's own patent EP1552210 and also in the publication U.S. Pat. No. 4,991,651.

The gripping means of the device will normally have an outer surface which is formed so that it will grip into the pipeline to keep the device fixed relative the pipeline. The gripping means are in addition often made of a hard material, as a steel alloy. When inserting the device in the pipeline there is a need for making sure that the inner surface of the pipeline is not damaged by the traveling of the device through the pipeline.

### BRIEF SUMMARY OF THE INVENTION

An aim with the present invention is to provide a device which does not harm the inner wall of the pipeline during transportation through the pipeline. There is also an aim to provide a device which is improved in relation to known devices.

According to the invention, there is provided a device for movement within a pipeline. This device may be a pig or a removable plug, which is introduced in to the pipeline and then pigged and or moved by a tractor unit within the pipeline. The device may be autonomous or have an umbilical to the surface. A pipeline in this application should be understood to be any pipe for transport of a fluid, as a riser, flexible riser, seabed pipeline, pipe between two installations and or an intercontinental pipeline. The pipeline may be submerged, run on land or even be embedded in the ground.

The device comprises a main body and gripping means. The main body may be formed by several body elements attached to each other but arranged movable relative each other, as end plate body elements and an intermediate body element. The gripping means comprises at least two gripping segments arranged around a circumference of the main body. These gripping segments are arranged movable between a retracted position out of contact with an inner wall of a pipeline and an extended position in contact with an inner wall of a pipeline. In an extended state of the gripping elements these will interact with the inner wall of the pipeline and keep the device fixed relative the pipeline. The gripping means may be of several kinds, gripping blocks moved by linked elements, wedge elements as for instance slips etc.

According to the invention there are arranged at least two protection means to the device, extending in a radial direction from the main body. The protection means will also extend in a radial direction from a main outer diameter of the main body. The at least two protection means are arranged around a circumference of the main body. A distal end of the protection means extends outside the grip segments in a retracted state of the grip segments but is within an outer diameter of the grip segments in an extended state of the grip segments.

According to one aspect, the protection means are arranged to be at least partly positioned between two neighbouring grip segments. In such an embodiment, the protection means may be attached to a part of the main body of the device and the gripping means arranged to be movable in relation to this part of the main body. One possible configuration is to have protection means and gripping means arranged alternating around a circumference of the main body of the device. There may of course also be other configurations of protection means and gripping segments around a circumference, as for instance a pattern of two gripping segments and one protection means and then two gripping segments around a circumference, or a pattern of one gripping segment, one protection means, two gripping segments, one protection means, one gripping segment etc. or a combination of these patterns.

According to another aspect, the protection means may be attached to the grip segments as such. This may be achieved by for instance having spring loaded protection means attached to the grip segment, which protection means will be depressed as the grip segment is extended into contact with an inner wall of a pipeline. This attachment of the protection means to the grip segment may, for instance, be in an outer surface of the grip segment. If the grip segment has a form with at least two contact sections between the grip segment and the pipeline wall either in a circumferential direction or a longitudinal direction of the pipeline or both, there is the possibility of positioning the protection means in the outer surface between such contact sections. By such a solution one still achieves the same contact surface between the grip segment and the pipeline, and in addition one also has the protection until the grip segment is set. According to yet another aspect, there may be a combination of protection means arranged at least partly between two neighbouring grip segments and attached to grip segments.

According to another aspect, the protection means may be formed by protection elements attached to the main body with connection means. The connection means may be snap in connections, screws or other kind of attaching means. The protection means may in a similar manner be attached to grip segments. It is also possible to envisage that the protection means are formed as an integral part of a part of the main body.

According to yet another aspect, at least a distal end of the protection means may be formed by a non-metallic material. It is also possible to envisage that the whole part forming the protection means attached to the main body or gripping segment is formed by a non-metallic material.

According to another aspect, the protection means may comprise rotation means at a distal end. Rotation means may be wheels, rollers or ball bearings. The distal end of the protection means may also be formed with skids, disks etc. The form of the distal end may also be different dependent on the use of the device. The part of the protection means forming the distal end may be angled and or curved in some sections to prevent the device to be caught or get stuck at elements within the pipeline or in narrow parts of a pipeline. These curved or angled sections will normally be the sections facing the traveling direction of the device within the pipeline.

In one aspect of the invention, the gripping means may comprise a bowl section formed by a part of the main body. The gripping segments in the form of slips elements will be movable along gliding surface sections of the bowl section for movement between the retracted and extended state of the gripping means. This may be achieved by having an end plate of the device in abutment against the slips and by moving the end plate relative the bowl section, the slips are moved between the retracted and extended state. The gliding surface sections may also be movable in a radial direction for rapid movement between a retracted and an extended state of the gripping means.

According to an aspect, the protection means may also extend in an axial direction of the device. The axial direction of the device will be a direction normally parallel to an axial direction of the pipeline wherein the device is used. The extension in the axial direction may be for at least a part of the bowl section.

In one aspect the device is a removable autonomous plug. There may be arranged sealing means in relation to the main body for sealing against an inner wall of a pipeline. The sealing means may be an annular packer element, arranged between two body elements, for instance an end plate and the bowl section, allowed to move relative each other in the axial direction of the plug for moving the packer element from a retracted state to an extended state in sealing contact with an inner wall of the pipeline.

The sealing means and or gripping means, in the form of an annular packer element and slips segments, may be actuated by relative movement of different body elements forming the main body of the device. The relative movements between the different body elements may be achieved with a centrally located fluid operated piston and cylinder arrangement, where the cylinder is connected to one end plate and the piston is connected to the opposite end plate, and when these are moved relative each other the gripping and sealing means are actuated.

According to yet another aspect, there may be arranged additional protection means at the axial ends of the device. These protection means may be of the same kind as the ones explained above or be of a different kind of protection means.

The main body of the device in this application should be understood to be the main body elements without the grip segments and the packer element. A main outer diameter of the main body will be an outer diameter of these elements. With gripping means in the form of slips arranged around a bowl section of the main body, a main outer diameter of the plug will normally be an outer diameter of the bowl section formed by one body element. The bowl section will normally be positioned centrally in the plug.

### BRIEF DESCRIPTION OF THE DRAWINGS

A non-limiting embodiment of the invention will now be explained with reference to the attached drawings, where,

FIG. 1 shows a partial cross section of a device according to the invention, as a plug, in a pipeline in an unset configuration

FIG. 2 shows the device in FIG. 1 in a sat configuration within the pipeline,

FIG. 3 shows a detail of FIG. 1 in more detail.

### DETAILED DESCRIPTION OF THE INVENTION

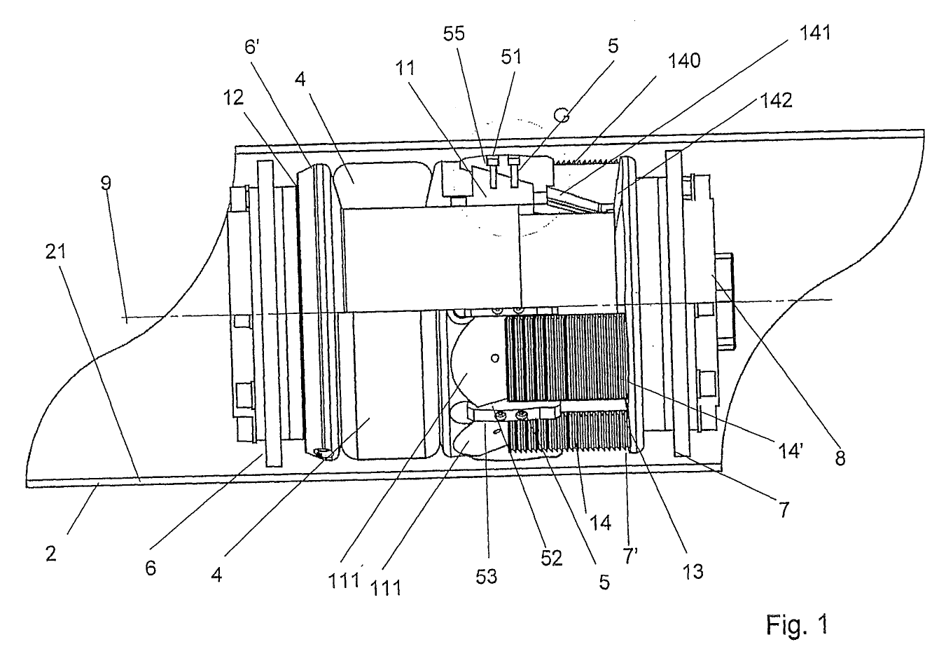

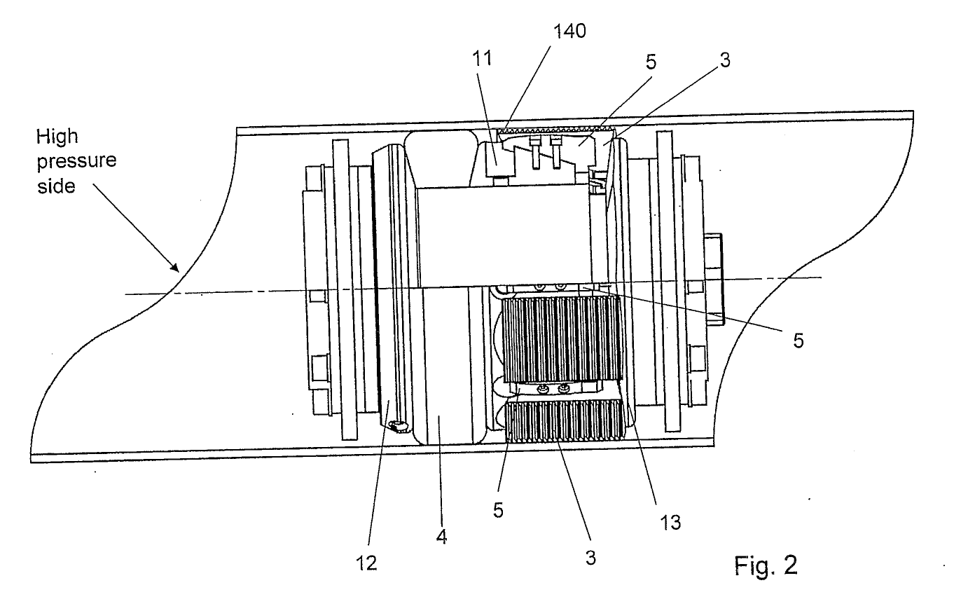

In FIGS. 1 and 2 the device according to the invention is shown in a partial cross section, where the middle part of the device in shown in a cross section, above a centre axis 9 of the device in the figures, and a side view of the device with the pipeline 2 removed is shown below the centre axis 9.

The device is in the shown example an autonomous plug for temporarily sealing off the pipeline 2 into two separate sections, with a high pressure side on the left hand side in FIG. 2. The plug comprises gripping means 3 and sealing means 4, which are moved from a retracted state, as shown in FIG. 1 when the plug is pigged through the pipeline 2 to an extended state where the gripping means 3 and sealing means 4 are in contact with an inner wall 21 of the pipeline 2, as shown in FIG. 2. The plug comprises further a main body comprising a bowl section 11, a first endplate 12 and a second end plate 13. The end plates 12, 13 form the axial ends of the plug and are facing the fluid on either side of the plug. With the configuration of the sealing means 4 and gripping means 3 as given in the shown embodiment, it is the first end plate 12 which will be facing a fluid with a higher pressure when there is a pressure difference across the plug in a set state of the plug.

The sealing means 4 comprises an annular packer element which is arranged between the first end plate 12 and the bowl section 11. The gripping means 3 comprises grip segments 14, 14′ arranged around a circumference of the main body. These grip segments 14 are movably attached to the bowl section 11, possibly by t-shaped grooves and protrusions. The grip segments 14 are wedge formed in a cross section and have an inner gliding surface 141 in abutment against a gliding surface section 111 of the bowl section. Gliding surface section 111 has an angle in relation to the center axis 9 of the plug. The grip segments 14 have further an outer gripping surface 140, which normally is formed with at least one section with higher friction factor than the rest of the outer surfaces of a grip segment 14. The grip segment is also formed with an end surface 142, which is in abutment against the second end plate 13. The gripping segments 14 are moved from a retracted state (FIG. 1) to an extended state (FIG. 2) by moving the end plates 12,13 towards each other. By this movement, the grip segments 14 are on the end surface 142 pushed by the end plate 13 in an axial direction and by this movement along the gliding surface section 111 of the bowl section 11 and thereby outwards in a radial direction to an extended state. In a similar manner, the sealing element 3 is pushed by the axial movement of the first end plate 12 relative the bowl section 11 and the second end plate 13, for movement of the packer element from a retracted state to an extended state. The movement of the end plates 12,13 is achieved by a centrally located piston and cylinder arrangement (not shown) within the plug, where the first and second end plates are connected to the piston and cylinder respectively.

According to the invention, there are arranged protection means 5 around a circumference of the main body of the plug, some of which are shown in the figures. The protection means 5 are in the shown embodiment attached to the bowl section 11 of the main body with connection means 55 in the form of bolts. As already said, there may be other kind of connection means for attaching the protection means to the main body and or alternatively to the grip segments. The protection means 5 are arranged in between the grip segments 14,14′, so that a part of the protection means 5 are arranged between the grip segments 14 in a retracted state of the grip segments 14 and the whole of the protection means are arranged between the grip segments 14 in an extended state of these. When looking around the circumference, there will be a repeating patter of a grip segment 14, a protection means 5, a grip segment 14, a protection means 5, etc. There may, of course, be other possible configurations of this and the axial positioning of the protection means may also be altered so that not the whole of the protection means are between the grip segments in an extended state of these.

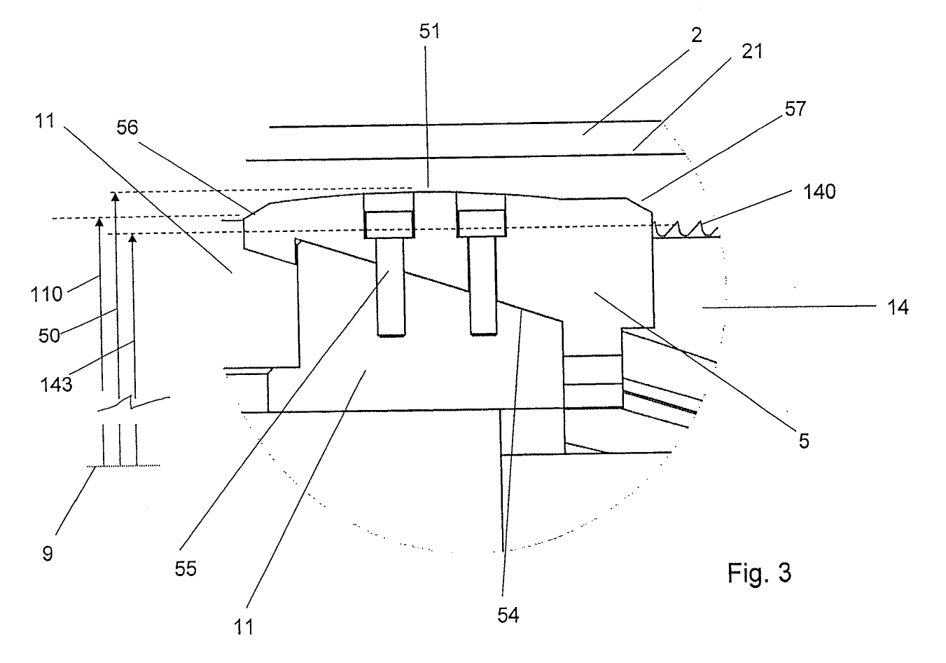

The protection means 5 are shown to have a length in the axial direction of the plug, this length may be varied dependent on the use of the device within the pipeline. In the shown embodiment, see FIG. 3, the protection means 5 comprises an outer surface 51, forming the distal end of the protection means 5. This outer surface 51 is shown with a first angled surface 56 facing the traveling direction of the plug. The outer surface 51 is also formed with a second angled surface 57. This second angled surface 57 is positioned at the opposite end of the outer surface 51 and is facing a traveling direction of the plug should it be pigged both ways, which may be happening in some cases. The outer surface 51 is also formed as a somewhat curved surface between these angled surfaces. These angled and curved surfaces give less possibility of the protection means to be caught up in a narrow section of the pipeline, or an element protruding into the pipeline, or makes it easier for the protection means to pass through a narrower section of the pipe.

The protection means 5 may also be formed without one or both of these angled surfaces. The outer surface may also be an almost linear surface and or have linear sections or a combination of linear, curved and angled. The protection means 5 are further formed with an inner surface 54 in abutment against a surface of the bowl section 11. This inner surface 54 is formed with two angled parts complimentary to a part of the bowl section, to keep the protection means 5 steady and fixed relative the bowl section 11. The outer surfaces 51 of the different protection means 5 arranged around one circumference of the main body, will also form a main outer diameter 50 for the protection means, as indicated in FIG. 3. Main outer diameter 50 is larger than a main outer diameter 143 formed by the gripping segments in a retracted state of the gripping segments, as indicated in FIG. 3. By this the protection means 5 will prevent the gripping segments from coming into contact with the inner wall 21 of the pipeline 2, when they are in a retracted state. The protection means 5 will therefore protect the inner wall 21 of the pipeline. As best shown in FIG. 1, the protection means 5 will also have a first side surface 52 and a second side surface 53, which side surfaces 52,53 are facing neighboring gripping segments 14, 14′, as indicated in FIG. 1.

The plug may be provided, in addition to the protection means 5 arranged in relation to the gripping segments or arranged at the gripping segment 14, with additional

protection means. These additional protection means will also have a distal end which extends outside the main outer diameter of the gripping segments in a retracted stated of the gripping segments. These additional protection means may be disks attached to the main body as indicated by reference numeral 6 and 7 in FIG. 1 and/or they may be formed as annular surface parts of the main body with a distal end formed by a non-metallic material, as for instance indicated with reference numeral 6′,7′ in FIG. 1. These additional protection means may also be skids, wheels or other elements preventing elements of the plug damaging the inner wall of the pipeline during transportation in the pipeline, with pigging and or tractor movement.

The plug as shown in the embodiment has a self locking system with a given pressure difference across the plug. This gives that with a higher pressures differential across the plug, a higher sealing pressure is established in the packer element of the plug.

The invention has now been explained with one embodiment. A skilled person will understand that there may be made several alterations or modifications to the embodiment within the scope of the invention as defined in the following claims. The protection means may be attached to the gripping means, there may be alternative configurations of gripping means and protection means. The protection means may be attached to the device in a different manner etc.

1. Device for movement within a pipeline, said device comprising:
a main body;
gripping means comprising at least two gripping segments arranged around a circumference of the main body, which gripping segments are arranged movable between a retractable position out of contact with an inner wall of a pipeline and an extended position in contact with an inner wall of a pipeline; and
at least two protection means arranged extending in a radial direction from a main outer diameter of the main body and arranged around a circumference of the main body, where a distal end of the protection means is extending outside the grip segments in an retracted state of the grip segments but is within an outer diameter of the grip segments in an extended state of the grip segments.

2. The device according to claim 1, wherein the protection means are arranged to be at least partly positioned between two neighboring grip segments.

3. The device according to claim 1, wherein the protection means are attached to the grip segments.

4. The device according to claim 1, wherein the protection means are formed by protection elements attached to the main body with connection means.

5. The device according to claim 1, wherein the distal end of the protection means are formed by a non-metallic material.

6. The device according to claim 1, wherein the protection means at the distal end comprises rotation means.

7. The device according to claim 1, wherein the gripping means comprises a bowl section formed by a part of the main body and the gripping segments in the form of slips elements, movable along a gliding surface sections of the bowl section for movement between the retracted and extended state of the gripping means.

8. The device according to claim 7, wherein the protection means extend in an axial direction for at least a part of the bowl section.

9. The device according to claim 1, wherein there are arranged sealing means in relation to the main body, for sealing against an inner wall of a pipeline.

10. The device according to claim 1, wherein there are arranged additional protection means at the axial ends of the device.
